(19) United States
(12) Patent Application Publication
(10) Pub. No.: US 2013/0220773 A1
(43) Pub. Date: Aug. 29, 2013

(54) PROCESS MACHINE, IN PARTICULAR FOR TREATING AND/OR INSPECTING SUBSTRATES

(71) Applicants: Jakob Szekeresch, Schomberg (DE); Klaus Oppelt, Beimerstetten (DE); Gerd Krause, Lochgau (DE)

(72) Inventors: Jakob Szekeresch, Schomberg (DE); Klaus Oppelt, Beimerstetten (DE); Gerd Krause, Lochgau (DE)

(73) Assignee: EKRA AUTOMATISIERUNGSSYSTEME GMBH, Bönnigheim (DE)

(21) Appl. No.: 13/878,354

(22) PCT Filed: Aug. 20, 2011
(86) PCT No.: PCT/EP11/04204

§ 371 Date: Apr. 8, 2013

(30) Foreign Application Priority Data
Oct. 11, 2010 (DE) 102010048909.3

(51) Int. Cl. B65G 37/00

(52) U.S. Cl. CPC B65G 37/005
USPC 198/576

(57) ABSTRACT

A process machine and a related method for treating and/or inspecting printed circuit boards, solar cells or the like, has at least one transport device for transporting the substrates and at least one process device for processing the substrates. The transport device and process device are both separate, self-supporting, modular units. The modular units can be selectively combined with one another in such a way that the transport device undertakes the transportation of the substrates through the process device.

The invention relates to a process machine, in particular for treating and/or inspecting substrates, in particular boards, printed circuit boards, solar cells or the like, having at least one transport device for transporting the substrate and having at least one process device for processing, in particular for treating and/or inspecting the substrates.

The invention also relates to a method centered thereon.

### PRIOR ART

Today's board printers, such as those used, for example, for printing boards, in particular printed circuit boards, have an infeed and an outfeed, wherein the boards to be printed are fed in via the infeed by means of a usually external conveyer device and the treated, in particular printed, boards are discharged once more from the outfeed by means of a usually external conveyer device and fed, for example, to a subsequent process. Today's substrate or board printers are integrated systems which have the process device which undertakes the actual treatment with its own transport path and the transport device for the boards within the process unit between infeed and outfeed. As a rule, also integrated into the board printer are inspection facilities, which for example make incorrect printing or inadequate printing visible and allow direct reworking in the board printer without the substrate to be printed, that is to say the board, having to be removed from the work flow. These board printers are capable of high capacity, particularly due to their high integration. Here, the particular treatment unit, which, for example, comprises a screen printing stencil for the passage of soldering paste and a screen printing squeegee, which applies soldering paste to the board or substrate through the screen printing stencil, and a lift and conveyer unit, which places the board on the screen printing stencil for the purpose of printing and feeds it to and removes it from the actual printing/treating location, are in each case built into the board printer. An example of such an integrated board printer is disclosed in DE 103 11 821. Because of the required high throughput speeds with consistently high and reliable precision, elaborate fixings, in particular screw fixings, which hold reliably in continuous operation, are necessary. As a result, established board printers disclosed in the prior art have the disadvantage that, when changing the product line for example, they have to be removed completely from the production flow, and the production line which includes these board printers stops. As a result, set-up times and changeover times in particular and also periods of downtime lead to a stoppage of production in the respective production line. Also, the established board printer can only be used for the task for which it has just been set up in the respective production line. As a result, established board printers are not ideally suited to small batches and applications in which very high flexibility is required, as their set-up times are comparatively long measured against the production run of a small batch. In particular, it is disadvantageous that the production line is stopped while such a board printer is being changed over for another product.

### DISCLOSURE OF THE INVENTION

The stated disadvantages are avoided with the proposed process machine, in particular for treating, in particular printing, and/or inspecting substrates, in particular boards, printed circuit boards, solar cells or the like, having at least one transport device for transporting the substrates and having at least one process device, in particular for treating and/or inspecting the substrates. It is provided that transport device and process device are in the form of separate, in each case self-supporting, modular units, wherein the modular units can be selectively combined with one another in such a way that the transport device undertakes the transportation of the boards through the process device. Unlike board printers which are established in the prior art, according to the invention, transport device and process device are in the form of separate modular units. In doing so, each of these modular units is self-supporting. By this is meant that, with respect to a given working height, they only vary this given working height by an insignificant amount when the transport device and process device are connected or disconnected. With an established board printer, if the treatment unit, that is to say the screen printing table or the screen printing stencil or the squeegee, for example, is removed, it must be stored on a carriage or rack for example. With the design according to the invention of the process machine, if the process device is released from the transport device, the process device and the transport device are in each case self-supporting. Storage or setting aside with additional means as is common in the prior art is not necessary here. Transport device and process device can be easily separated from one another and joined together again. Here, the modular units are designed so that the transport device undertakes the transportation of the substrates through the process device. Unlike integrated board printers established in the prior art, the transportation is consequently not carried out by mechanisms of the board printer itself but by the transport device, which is in the form of a separate modular unit and is combined with the process device for this purpose. It is consequently possible to combine a transport device with the one or other process device depending on the requirement for the application. In particular, compared with the prior art, this results in the advantage that a first process device can be combined with the transport device and can produce in continuous production mode while another process device, which is currently not combined with the transport device, is changed over for a new, different production run. At the end of the production run of the first process device, the second process device, which in this way is changed over outside the actual manufacturing system, can be easily combined with the transport device in place of this first process device, as a result of which only a minimal amount of time is lost for removing the first process device and joining the second process device to the same transport device in each case. A very much higher flexibility of production flows in assembly lines can be achieved in this way. In particular, possible failures of process devices can also easily be buffered in this way if, for example, a second process device, which only has to be inserted into the manufacturing system in place of the first process device should it fail, is available as a replacement. In this way, production can continue as long as the first, defective process device is being restored.

In a further embodiment, it is provided that the transport device and/or the process device is/are in each case provided with a travelling chassis and/or a foot stand. Transport device and/or process device can be moved from one position to another by means of the travelling chassis without great effort. In particular, in order to combine transport device and process device, it is very easily possible to move at least one of the two devices to enable it to be moved into position for combining with the other device in each case. In particular, it is advantageously possible here, to provide the transport device, for example, with a foot stand and the process device with a travelling chassis so that the transport device remains substantially stationary, whereas the process device can be easily moved by means of the travelling chassis. Particularly advantageously, both transport device and process device have a combination of travelling chassis and foot stand, wherein, to transport one of the two devices, the travelling chassis is activated, for example by means of a lever mechanism which is common in the prior art, but, for production mode, the travelling chassis is deactivated and the foot stand is used for fixed, stationary standing. In this way, fixed and reliable standing on the one hand can be very advantageously combined with easy transport capability on the other.

Further, it is advantageously provided that a plurality of transport devices, which can be combined with one another in such a way as to form at least one common transport line for the substrates, are provided. The transport device according to the invention is consequently not only used for transporting substrates or substrate to be printed or treated through the process device, but is also designed in such a way that it can be extended to form a transport line by combining a plurality of transport devices. For this purpose, the transport devices are designed as independent modules in such a way that the infeed of the substrates takes place at their one end of the transport path, which is realized, for example, by a conveyor belt in the form of an endless conveyor path, and the outfeed, for example the transfer to the next transport device, takes place at the respective other end of the conveyor path. A plurality of such transport devices can consequently be combined to form any transport line. This enables a continuous manufacturing line or assembly line to be formed.

Preferably, it is provided that at least one of the process devices of the transport line can be associated with a selectable position. A process device can consequently be associated with a transport line formed from a plurality of transport devices at a selectable position, in particular, at the same time, it is provided that a plurality of process devices can be associated with a transport line so formed. Consequently, it is possible to form a continuous transport line from a plurality of (similar) transport devices, for example in the form of an assembly line, wherein process devices can be arranged at any selectable positions in this transport line. Important here is the advantage that different process devices can undertake different tasks, for example one process device realizes the process of printing and another process device realizes the process of board or substrate separation or inspection. Transport devices and process devices can be freely combined in accordance with selectable criteria to form the assembly line. However, a degree of flexibility is achieved which is very advantageous not only from the point of view of the method flow but also spatially.

As already mentioned, it is particularly advantageous that a plurality of process devices, which have different functions, in particular treatment functions and/or inspection functions for the substrates, are provided. Unlike integrated board printers established in the prior art, one process device, for example, carries out only one task, for example the printing of the board or the substrate. Another process device downstream thereof effects the inspection for example. Such arrangements are not compulsory but are intended to indicate that the proposed modular system consisting of process devices and transport devices allows the particular user an extraordinary amount of freedom in the construction and design of his production flow and his assembly line. This is exceptionally advantageous, particularly for small batch manufacturing systems with very short model cycles, as, for example, substantially unchanging tasks, such as the separating of substrates or inspection tasks, can be undertaken by one process device which remains substantially unchanged in the assembly line, whereas the printing of the substrate for the respective circuits and models currently being produced is undertaken by dedicated process devices, of which one is already being set up while another is still producing. In order to change the product to be manufactured, the process device which was initially in production is removed from the line and the process device for the new product is moved into its place. Alternatively, it is also possible to bring a process device which is switched off but has already been set up for the new product into position, for example before or after the process device that is still manufacturing, that is to say to combine it with the respective transport unit, but not yet put it into operation. This enables the down times and setup times of an assembly line to be reduced to an exceptionally great extent.

For this purpose, it is preferably provided that at least one print device, one inspection device, one depanelling device, one marking device, one identification device, one drying device and/or one oven device are provided as process devices. As described above, the different process devices can be selectively combined with the transport device. If, for example, an overall printed circuit board is to be separated, then the depanelling device is combined with the transport device. If substrates are to be marked or if marked substrates are to be identified, then the marking device and the identification device respectively are combined with the transport device accordingly. For drying and/or heating, the drying and/or oven devices are combined with the transport device. Other process devices which are not mentioned here can, of course, also be provided.

In another advantageous design, it is provided that the transport device has one transport line section or a plurality of transport line sections. The at least one transport line section is formed by the conveyor device of the transport device. The transport line section is the section of the transport line formed by a plurality of transport devices which is formed by the beginning of the conveyor device to the outfeed of the conveyor devices of the respective individual transport device. In particular, it is provided that the transport device has a plurality of parallel-running transport line sections, that therefore a plurality of similar or different substrates and substrate sizes can be conveyed in parallel on the same transport device but on different transport line sections.

Preferably, it is also provided that at least two transport devices can be arranged next to one another perpendicular to the transport direction to form at least two parallel transport lines. The transport devices can consequently be combined in such a way, for example back-to-back, that their parallel transport line sections form at least two parallel transport lines. In doing so, the direction of travel of the transport devices is freely selectable, in particular reversible. The figures show more detail.

Particularly preferably, it is provided that each transport device and/or each process device has at least one dedicated drive. Here, drive not only means a mechanism for moving boards or similar which are to be transported or treated, but also any source of power in the form of a motor which enables transportation or the carrying out of the process in transport devices or in the process device. In this way, every transport device and every process device is independent with regard to the particular operations to be effected thereby. The modular concept of the invention is therefore taken into account in a particularly advantageous manner, as namely each transport device and each process device forms an independent unit in its own right which can be used at freely selectable positions within a production process. In the same way, it is provided that the process device and the transport device are not dependent on the assembly line drives. Each process device and each transport device preferably has its own drive device for the processes to be carried out therein and therewith in each case.

Further, it is provided that in each case the process device has at least one infeed mouth for the partial or complete acceptance of at least one transport device. Here, infeed mouth is understood to mean such an open-edged cutout in the process device which, depending on the width of the process device, overlaps or encompasses the transport device for the purpose of combining with one or more transport devices. The infeed mouth consequently encompasses the at least one transport device when the process device is combined with the transport device. At the same time, a process device can also overlap two or more transport devices if they are designed accordingly.

Preferably, it is further provided that, for the partial or complete acceptance of the at least one transport device, the process device can be moved/fed towards said transport device transversely, in particular perpendicular to the transport direction of the transport device. The transport direction of the boards of the at least one transport device (for example when forming a transport line as described above) is consequently in the one direction, and the movement or feeding of the process device towards said transport device takes place perpendicular thereto. In such an embodiment, the process device can be easily removed from and fed in again to an existing transport device, which is part of a transport line/assembly line, perpendicular to the transport direction of the substrates. Process device and transport device of a transport line can consequently be easily separated and recombined without the need for intervention in the transport line. The process device is simply removed and fed in again perpendicular to the flow of the transport line, for example after a changeover.

Particularly preferably, the transport device and the process device have automatically coupling connector and/or alignment elements when feeding the modular units together. In this way, when transport device and process device are combined/fed together as described above, on the one hand it can be ensured by means of the alignment elements that the positional accuracy necessary for the treatment process and the manufacturing process can be reproducibly set and maintained with high precision, wherein for their part the automatically coupling connector elements effect electrical connections, for example for transmitting energy/electricity and/or data. Here, the automatic coupling is preferably carried out in such a way that it is forced to take place when feeding in or moving in perpendicular to the transport direction of the transport device without further action by an operator. Advantageously, in this way, the manual connection of cables and plugs/sockets can be avoided. It is also thereby ensured that all necessary electrical contacts are made without further action by a user/mechanic/electrician. Errors in the spatial-mechanical alignment of process device and transport device with respect to one another can likewise be advantageously avoided by the automatic action of the alignment elements. For this purpose, the alignment elements can, for example, be formed by rails or skids or as bush/pin pairs, which, for example, preferably have angled or wedge-shaped feed-in and/or alignment aids.

A plurality of transport devices and at least one process device are therefore provided to form an assembly line. In doing so, the transport device effects the continuous inflow and outflow of substrates to be treated or which have been treated respectively in the process device. Assembly lines, which in particular take into account the short product cycles of modern electronic products, for example mobile phones, can be formed particularly flexibly and cost-effectively in this way.

In a preferred embodiment, it is provided that the transport device substantially has a C-shape, wherein the C has an upper and a lower arm and a central piece which connects the arms, and wherein the arms of the C are arranged substantially perpendicular to the transport direction of the transport device.

Further, it is provided that the process device substantially has a C-shape, wherein the arms of the C of the process device lie substantially perpendicular to the transport direction of the transport device when the process device is combined with the transport device. The C can also be interpreted as a sideways U.

Advantageously, it is provided that the arms of the C of the transport device and the arms of the C-shape of the process device mesh with one another when transport device and process device are combined. The arms of the respective C-shapes of transport device and process device are consequently not at the same height which would enable them to be combined face-to-face, but have different heights with respect to a reference level, for example a floor. When the process device is combined with the transport device, the arms of the respective C mesh with those of the other in each case. The figures show more detail.

Furthermore, a method is proposed for processing substrates, in particular boards, printed circuit boards, solar cells or the like, having at least one transport device for transporting the substrates and at least one process device, in particular for treating and/or inspecting the substrates. Here, it is provided that the transport device and the process device are combined in the form of separate, in each case self-supporting, modular units, in such a way that the transport device undertakes the transportation of the substrates through the process device. Unlike board printers established in the prior art, the transportation of the substrates through the process device is consequently effected by the transport device.

Further advantageous embodiments can be seen from the dependent claims and from combinations thereof.

The invention is explained below based on individual exemplary embodiments without, however, being restricted thereto.

In the drawing

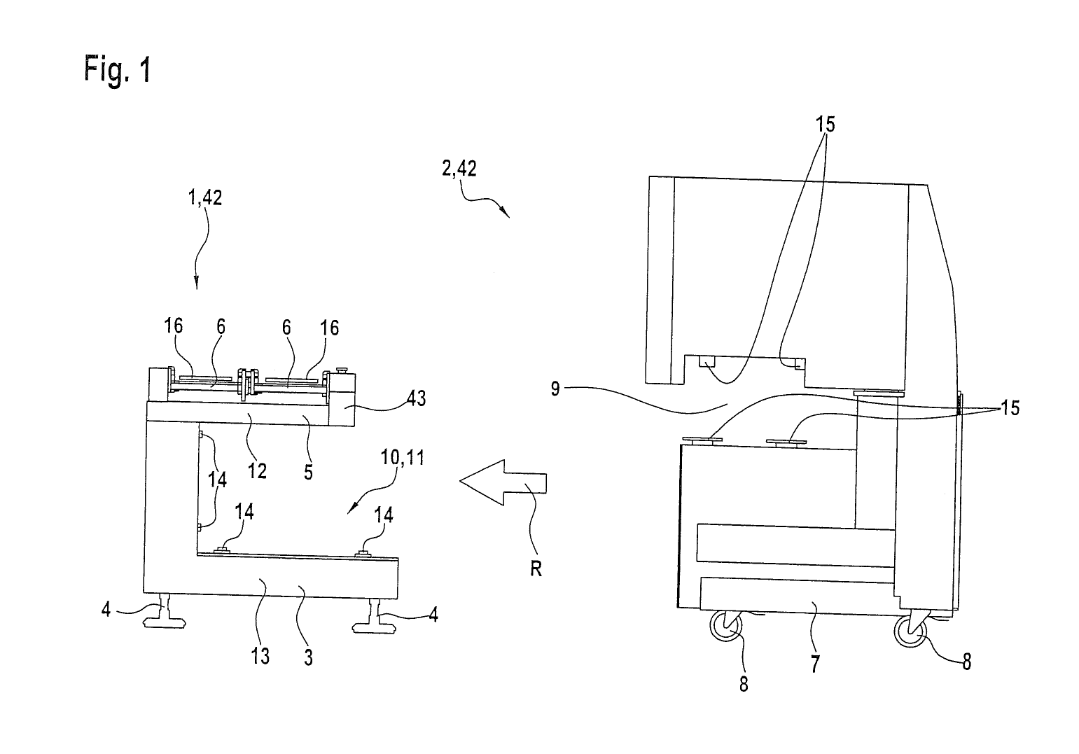

FIG. 1 shows a transport device and a process device in side view;

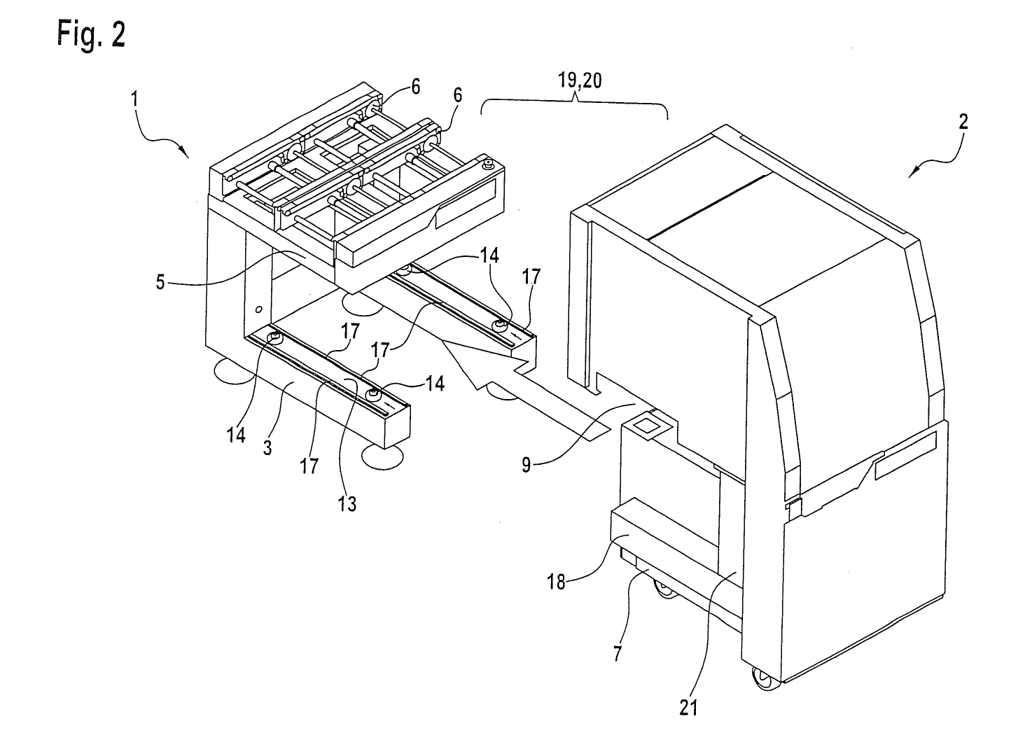

FIG. 2 shows a transport device and a process device in a three-dimensional diagram;

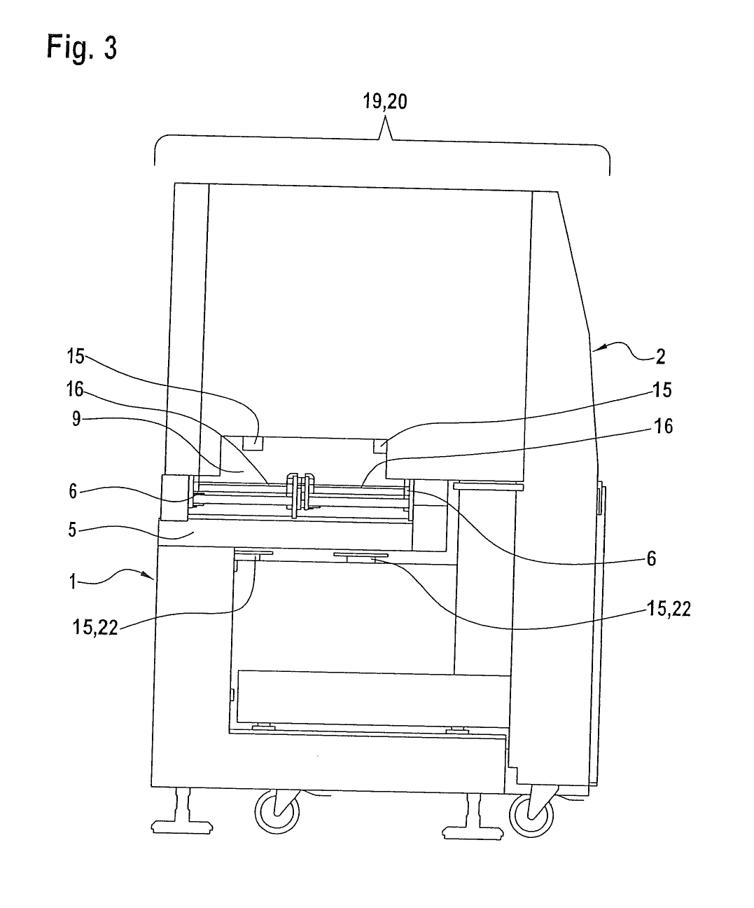

FIG. 3 shows a transport device and a process device combined to form a board printer;

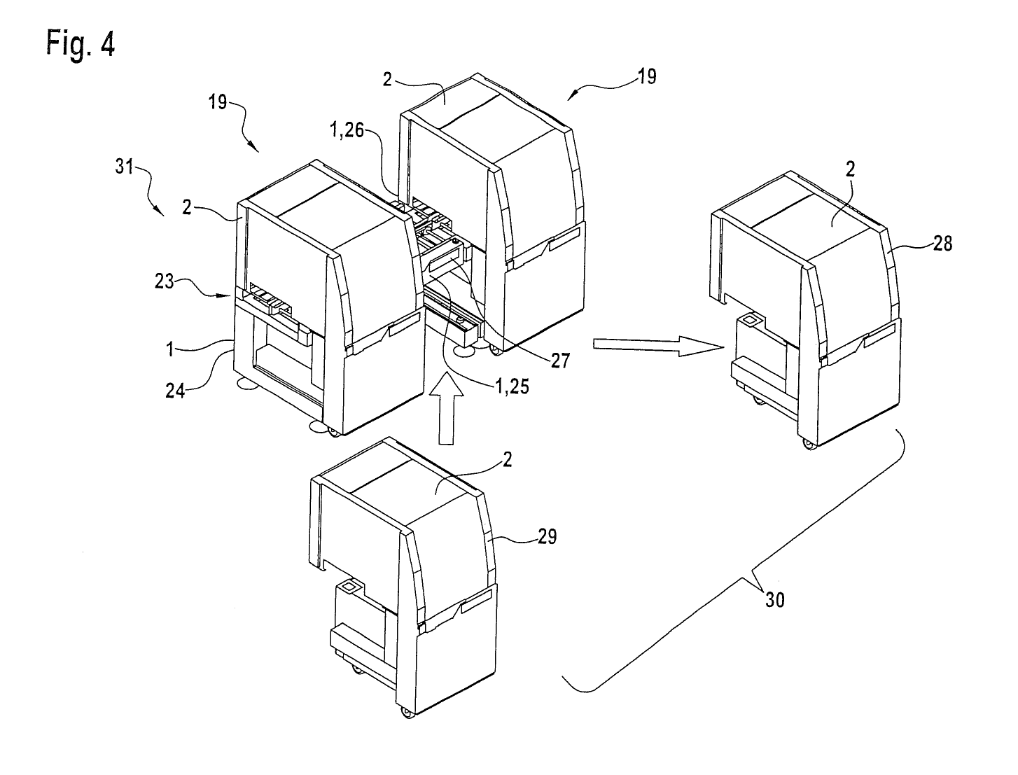

FIG. 4 shows an assembly line of a plurality of board printers connected consecutively;

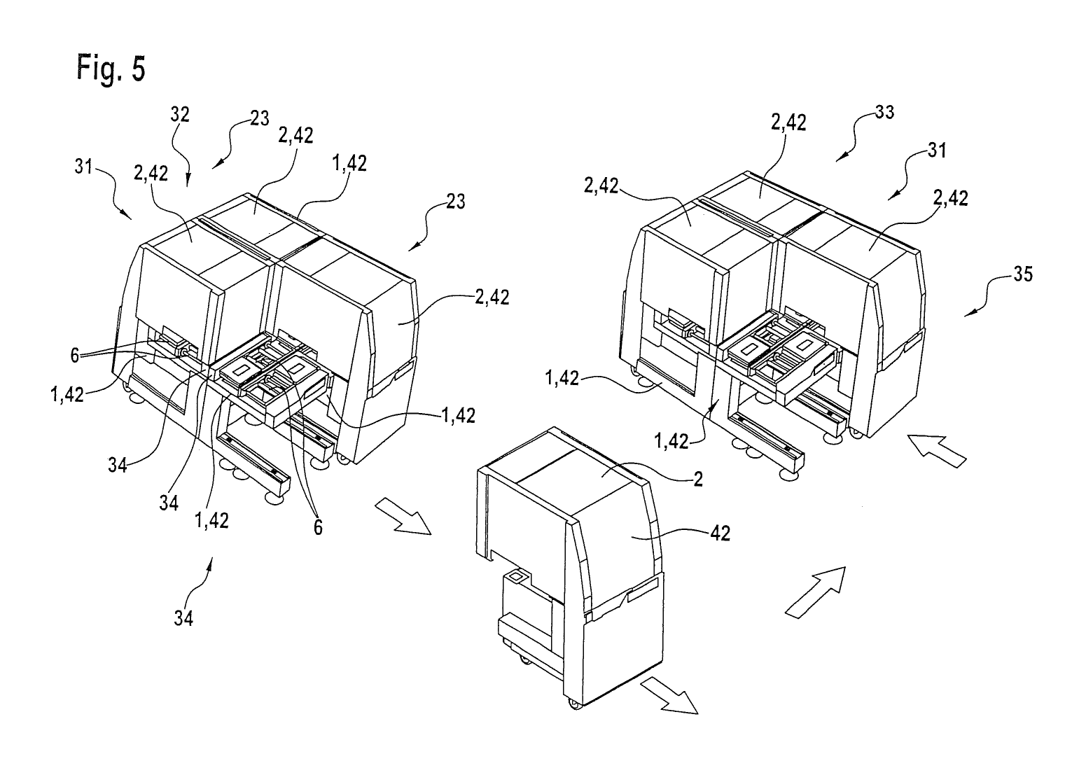

FIG. 5 shows an assembly line of a plurality of board printers;

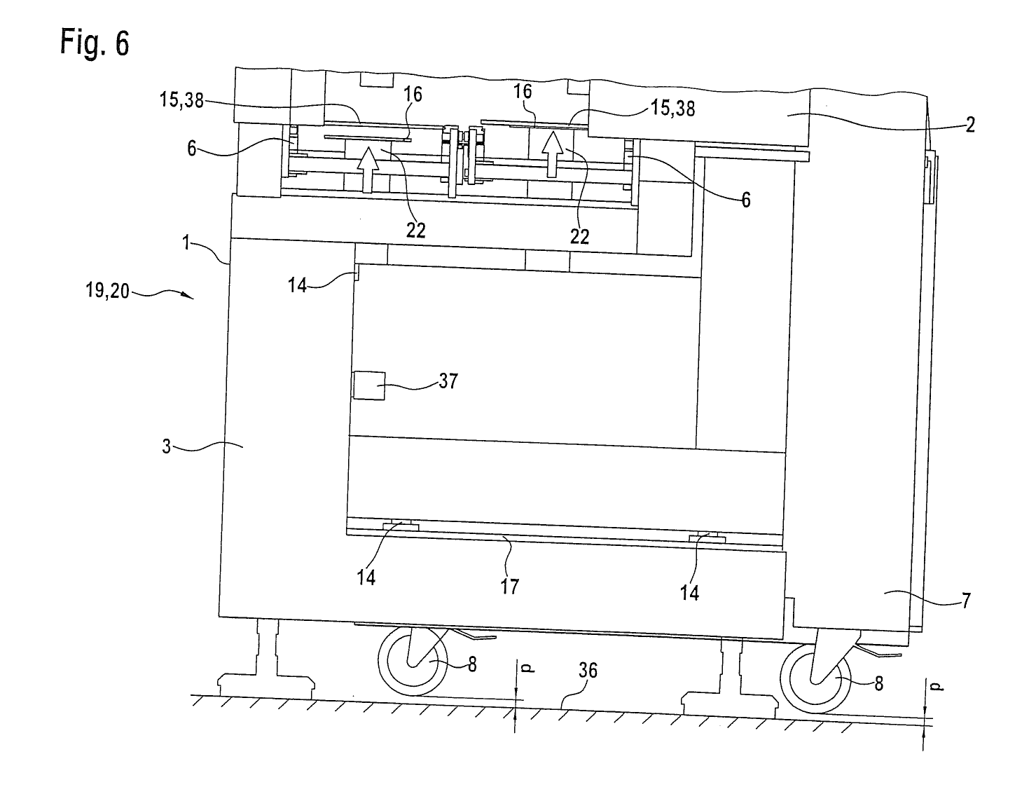

FIG. 6 shows connector and alignment elements on process device and transport device;

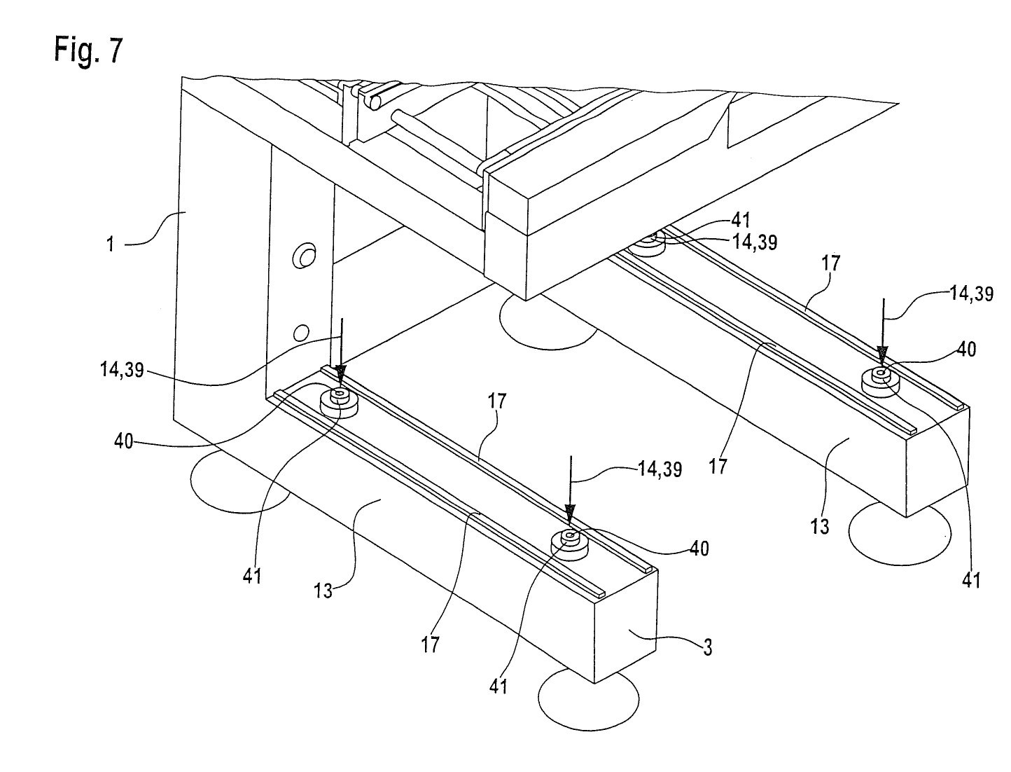

FIG. 7 shows alignment elements on the transport device, and

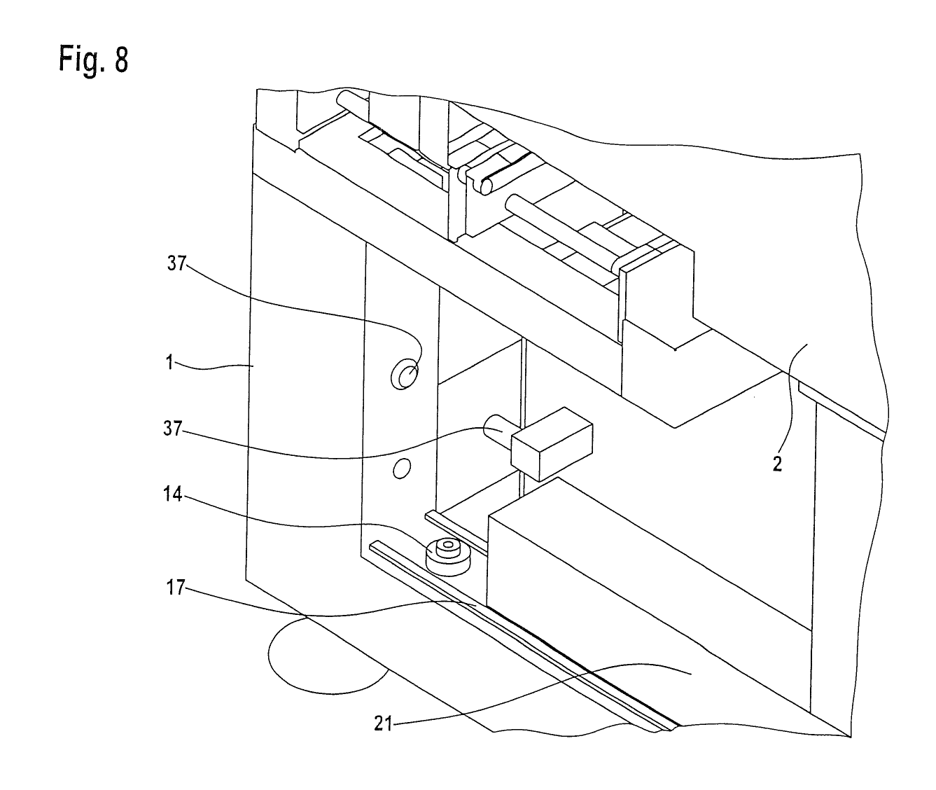

FIG. 8 shows connector and alignment elements when a transport device and process device are joined together to form a board printer.

FIG. 1 shows a transport device 1 and a process device 2 in side view, wherein both TE1 and PE2 are in each case in the form of independent, self-supporting modular units 42. The transport device 1 has a foot stand 3, which is substantially L-shaped and is provided on the underside with preferably adjustable stand elements 4 for setting up the transport device 1 at the correct level. On the top side, the foot stand 3 supports a conveyor device 5, which, in the present exemplary embodiment, has two parallel-running endless conveyor elements 6 which are driven by a dedicated drive 43 (not shown here) in the transport device 1. The process device 2 has a travelling chassis 7 with braked castors 8 which allow a movement of the process device 2 by means of the travelling chassis 7, in particular towards the transport device 1 and away from the transport device 1. The process device 2 is designed to be movable towards the transport device 1 for at least partial acceptance thereof. For the purpose of such acceptance, the process device 2 has an infeed mouth 9, wherein the infeed mouth 9 of the process device 2 encompasses at least the conveyor device 5 of the transport device 1 at least on the top and underside when the process device 2 is fed in. For this purpose, the transport device has a C-shape 10, wherein the C 11 of the C-shape 10 has an upper arm 12 which is formed by the conveyor device 5 and a lower arm 13 which is formed by a part of the foot stand 3 of the transport device 1 which is substantially parallel to the conveyor device 5. When transport device 1 and process device 2 are moved together in the direction of the arrow R, transport device 1 and process device 2 are automatically brought into the required position for carrying out the process, for example the printing of substrates, in particular boards 16 with solder paste (not shown), when transport device and process device 2 are joined together, so that the relative position of transport device 1 and process device 2 with respect to one another is specified exactly and reproducibly. This ensures that the treatment elements 15 (shown only by way of example) of the process device 2 provided for carrying out the process are in the correct relative position with respect to boards 16 conveyed on the endless conveyor element 6 of the transport device 1.

FIG. 2 shows the transport device 1 and the process device 2 in a three-dimensional view. The transport device 1 has the foot stand 3 with the alignment elements 14 on the lower arms 13 of the foot stand 3 and slide rails 17 on the top side of the lower arm 13 which enable a support element 18 of the process device 2 to be slid on in a defined, aligned manner when the process device 2 is fed towards and combined with the transport device 1 to form a process machine 19, in particular a board printer 20. Here, the support element 18 is part of a chassis 21 of the process device 2 which, along with the support element 18, comprises further stability-providing and supporting elements of the process device 2, and which is interactively connected to the travelling chassis 7 in such a way that the travelling chassis 7 permits the process device 2 to be fed towards the transport device 1, wherein, when the support element 18 of the process device 2 is slid onto the slide rails 17 of the transport device 1, the chassis 21 is preferably joined by force to the foot stand 3 of the transport device 1, so that the castors 8 on the travelling chassis 7 of the process device 2 can be folded away, retracted or braked and a relative movement of the process device 2 with respect to the transport device 1 cannot easily or accidentally occur. Here, the infeed mouth 9 of the process device 2 encompasses the conveyor device 5 of the transport device 1 in such a way that it is completely overlapped by the process device 2, and substrates (not shown here), for example boards, conveyed on the endless conveyor elements 6 of the conveyor device 5 can be treated and/or inspected by the process device 2.

FIG. 3 shows a transport device 1 and a process device 2 which are joined together and interact with one another to form the process machine 19, namely the board printer 20. The infeed mouth 9 of the process device 2 completely overlaps the conveyor device 5 of the transport device 1 in such a way that boards 16 conveyed on the conveyor device 5 by means of the endless conveyor elements 6 can be treated by the treatment elements 15 of the process device 2. For this purpose, treatment elements 15 of the process device 2 located on the underside of the conveyor device 5 in the joined-together state shown are in the form of lifting elements which lift the boards 16 from the endless conveyor elements 6 of the transport device 1 and bring them into a suitable treatment position, for example above the endless conveyor elements 6, within the process device 2 for the purpose of treatment. When treatment is complete, the lifting elements 2 lower and place the now treated boards 16 back on the endless conveyor elements 6 of the transport device 1 so that they are conveyed by means of the transport device 1 out of the process device 2, for example to be transferred to a further downstream transport device 1 for further treatment or for removal.

FIG. 4 shows a transport line 23 which is formed by three consecutively connected transport devices 1, namely a first transport device 24, a second transport device 25 and a third transport device 26. Here, the first transport device 24 and the third transport device 26 are in each case interactively combined with a process device 2, as a result of which a print and/or inspection machine 19 is formed in each case. In this diagram, the second transport device 25 is not combined with a process device 2; consequently, a process machine 19 is not formed and only a transport line section 27, which is formed by the second transport device 25, which, when connected to the first transport device 24 and followed by the third transport device 26, forms the transport line 23, is provided. The transport line 23 can consequently be subdivided into transport line sections 27, wherein each transport line section 27 corresponds to the conveyor length of a conveyor device 5 of each transport device 1. A plurality of transport line sections 27, which are realized by a plurality of transport devices 1 and their respective conveyor device 5 with the endless conveyor elements 6, consequently form the transport line 23. A transport line 23 of any length which is suitable for the respective applications can therefore be formed from a plurality of transport devices 1, wherein each transport device 1 can be combined with a process device 2 at any position necessary or expedient for the treatment process or the required manufacturing process in such a way that the treatment of the boards 16 to be treated in each case takes place at the required position in the course of the manufacturing process. If in the course of such a transport line 23 a process device 2 is to be changed because, for example, it is defective or is to be changed over, this process device 2, shown by way of example for the second process device 28 which was located on the second transport device 25, is withdrawn from the transport line 23, namely from the transport device 1 with the respective transport line section 27 assigned thereto, and replaced by another process device 2, here shown by way of example by a 2a-process device 29. In this way, the transport line 23 with the currently running manufacturing process is not blocked for an unnecessarily long time due to changeover times or failures or maintenance work of an individual process device 2 or, as is common in the prior art, of an individual process machine, rather the process device 2 to be maintained or changed over can be withdrawn from the transport line 23 in a very short time, that is to say taken out of the ongoing manufacturing process, and replaced by another process device 2, whereby the manufacturing process can be very quickly resumed or continued or restarted with other products. As a result, a system 30 of transport devices 1 and process devices 2 can be realized to form highly flexible assembly lines 31.

FIG. 5 shows two sections of two assembly lines 31, namely a first assembly line section 32 and a second assembly line section 33. Each assembly line section 32, 33 is formed by four transport devices 1, which in each case are placed with their backs next to one another in pairs, and the transport line sections 27 of which in each case have two parallel endless conveyor elements 6, so that each assembly line section 32, 33 has a total of four parallel-running endless conveyor elements 6, and therefore conveys in four lanes. A process device 2 is in each case interactively associated with the individual transport devices 1 which form the transport line section 27 of the transport line 23, wherein, in order to transfer a treatment station from a first assembly line 34 to a second assembly line 35 because of product manufacturing requirements for example, one or more of the transport devices 2 can be decoupled from the first assembly line 34 and combined with a transport device of the second assembly line 35. Very advantageously, it is therefore possible to change process devices 2 of one assembly line 31, for example the first assembly line 34, to another assembly line 31, for example the second assembly line 35, for the purpose of rapidly changing treatment steps/treatment stations. Particularly with very short-lived products and electronic products with short product cycles, an extraordinarily flexible manufacturing capacity, which can be quickly changed over in ongoing production, can be effected in this way. Consequently it is not only possible, as shown in FIG. 4 for example, to swap a process device 2 for another process device 2 within one and the same assembly line 31 if, for example, the process device 2 which is to be replaced is defective or is to be changed over, but in addition it is also possible, as shown in FIG. 5, to transfer process devices 2 from one assembly line 31 to another assembly line 31, for example from the first assembly line 34 to the second assembly line 35. Very advantageously, the advantages of the system 30 of transport devices 1 and process devices 2 are here too highlighted in the form of combinable modular units 42.

FIG. 6 shows in side view a section of a process machine 19 as described above, namely a board printer 20. As described, this has the transport device 1 with the foot stand 3 and the process device 2 with the travelling chassis 7, wherein the travelling chassis 7 has castors 8, which however are at a distance d from a mounting surface 36 for the process machine 19, as the travelling chassis 7 is moved on the slide rails 17 of the foot stand 3 of the transport device 1 shown in FIG. 2 and the castors 8 are raised from the mounting surface 36 to effect a safe and immovable standing of the process machine 19. Here, the process device 2 is positioned in the required relative position relative to the transport device 1 by means of the alignment elements, which have already been described in FIG. 2 and are shown again here, and connected electrically and brought into contact with regard to data transmission by means of automatically coupling connector elements 37. Here, both the alignment elements 14 and the connector elements 37 are designed to work automatically so that they are forced to assume the required position and make contact. It is therefore unnecessary for an operator or machine supervisor to intervene to align transport device 1 and process device 2 relative to one another and to connect the same. Here, the process device 2 has the already described lifting elements 22 which lift the boards 16 from the endless conveyor elements 6 of the transport device 1 and bring them into the relative position with respect to treatment elements 15 of the process device 2, for example screen printing devices 38, required for treatment. After treatment on or by means of the treatment elements 15, the boards are replaced on the endless conveyor elements 6 of the respective transport device 1 by downwards movement of the lifting elements 22 so that they can be conveyed out of the area of the process device 2 by means of the endless conveyor elements 6.

FIG. 7 again shows by way of example alignment elements 14 which are arranged between parallel-running slide rails 17 on the top side of the lower arms 13 of the foot stands 3 of transport devices 1. Here, the alignment elements 14 are preferably designed as alignment elements 39 that can be levelled, that is to say in such a way that they can be individually finely adjusted in the alignment of their contact surfaces 40 or side contact surfaces 41 in such a manner that the required relative alignment of the process device 2, which rests thereon and is not shown in FIG. 7 but can be easily seen from FIG. 6, can be effected. Such alignment elements 14 are preferably cone-shaped or formed in some other geometrical shape which automatically effects a required alignment, at least in sections, so that the required alignment of the process device 2 which slides and then sits thereon adjusts itself relative to the transport device 1 by itself due to the geometry of the alignment elements 14.

As an alternative to designing the alignment elements 14 as alignment elements 39 that can be levelled, in an exemplary embodiment, which is not shown here, the alignment elements 14 are in the form of ball castors which are arranged in the foot stand 3 while the support element 18 preferably has a flat surface which is/can be associated with the foot stand 3 and the ball castors. At the same time, the process device 2 and the transport device 1 are preferably designed in such a way that the process device 2 is moved into the transport device 1, lowered onto the ball castors and then aligned and fixed.

FIG. 8 shows, in sectional form, the transport device 1 while a process device 2 is being fed in, namely while its chassis 21 is being slid onto the slide rails 17. Here, the relative position of process device 2 and transport device 1 is brought about automatically by the alignment elements 14 as described above. The electrical and data connection is brought about by the automatically acting connector elements 37 which automatically make contact when process device 2 and transport device 1 are brought together.

1-17. (canceled)

18. A process machine for treating and/or inspecting printed circuit boards, solar cells or the like, the process machine comprising:
at least one transport device for transporting the substrates and at least one process device for processing the substrates, the transport device and process device in each is a separate, self-supporting, modular unit, wherein the modular units are selectively combinable with one another in such a way that the transport device undertakes the transportation of the substrates through the process device.

19. The process machine of claim 18, wherein at least one of the transport device and/or the process device is provided with at least one of a travelling chassis and a foot stand.

20. The process machine of claim 18, wherein the at least one transport includes a plurality of transport devices, which can be combined with one another in such a way as to form at least one common transport line for the substrates.

21. The process machine of claim 18, wherein at least one of the process devices of the transport line can be associated with a selectable position.

22. The process machine of claim 18, wherein the at least one process device includes a plurality of process devices, which have different functions, in particular treatment functions and/or inspection functions, for the substrates.

23. The process machine of claim 18, wherein at least one print device, one inspection device, one depanelling device, one marking device, one identification device, one drying and/or oven device are provided as the process device.

24. The process machine of claim 18, wherein the transport device includes at least one transport line section.

25. The process machine of claim 24, wherein the at least one transport device includes at least two transport devices arrangeable next to one another perpendicular to the transport direction to form at least two parallel transport lines.

26. The process machine of claim 18, wherein each transport device and/or each process device has at least one dedicated drive.

27. The process machine of claim 18, wherein the process device has at least one infeed mouth for the partial or complete acceptance of at least one transport device.

28. The process machine of claim 18, wherein the process device can be moved/fed towards the transport device perpendicular to the transport direction of the transport device for partial or complete acceptance of the at least one transport device.

29. The process machine of claim 18, wherein the process device and the transport device have automatically coupling connector and/or alignment elements when feeding the modular units together.

30. The process machine of claim 18, wherein a plurality of transport devices and at least one process device are provided to form an assembly line.

31. The process machine of claim 18, wherein the transport device substantially has a C-shape, wherein the C has an upper arm and a lower arm and a central piece which connects the arms, and wherein the arms of the C are arranged substantially perpendicular to the transport direction of the transport device.

32. The process machine as claimed in claim 18, wherein the process device substantially has a C-shape, wherein the arms of the C of the process device lie substantially perpendicular to the transport direction of the transport device of the boards when the process device is combined with the transport device.

33. The process machine of claim 18, wherein:
the transport device substantially has a C-shape, wherein the C has an upper arm and a lower arm and a central piece which connects the arms, and wherein the arms of the C are arranged substantially perpendicular to the transport direction of the transport device; the process device substantially has a C-shape, wherein the arms of the C of the process device lie substantially perpendicular to the transport direction of the transport device of the boards when the process device is combined with the transport device; and
the arms of the C of the transport device and the arms of the C-shape of the process device mesh with one another when transport device and process device are combined.

34. A method for inspecting and/or treating printed circuit boards, solar cells or the like, having at least one transport device for transporting the substrates and having at least one process device for processing, in particular for treating and/or inspecting the substrates, the transport device and the process device combined in the form of separate, in each case self-supporting, modular units, in such a way that the transport device undertakes the transportation of the substrates through the process device.
